(19) United States
(12) Patent Application Publication
(10) Pub. No.: US 2021/0070968 A1
(43) Pub. Date: Mar. 11, 2021

(54) Process for Producing Polymer Compositions Having Multimodal Molecular Weight Distribution

(71) Applicant: ExxonMobil Chemical Patents Inc., Baytown, TX (US)

(72) Inventor: Dongming Li, Houston, TX (US)

(21) Appl. No.: 16/644,817

(22) PCT Filed: Jun. 28, 2018
(86) PCT No.: PCT/US2018/040072

§ 371 Date: Mar. 5, 2020

Related U.S. Application Data
(60) Provisional application No. 62/564,685, filed on Sep. 28, 2017.

(51) Int. Cl. C08L 23/08; B29C 48/00; C08J 3/00

(52) U.S. Cl. CPC C08L 23/0815; B29C 48/022; C08L 2203/30; C08L 2205/025; C08J 3/005

(57) ABSTRACT

A process is described for producing a multimodal polymer composition comprising a high molecular weight polymer (1) and a low molecular weight polymer (2), wherein the weight ratio of polymer (1) to polymer (2) is at a first value, x. The process comprises compounding in a first compounding stage a mixture of polymer (1) and polymer (2), wherein the weight ratio of polymer (1) to polymer (2) in the mixture is at a second value, y, such that y>x to form a first blend. Polymer (2) is then added to the first blend and the mixture of polymer (2) and the first blend is compounded in a second compounding stage to produce a second blend.

### CROSS REFERENCE TO RELATED APPLICATIONS

This application claims the benefit of Ser. No. 62/564,685, filed Sep. 28, 2017, the disclosure of which is hereby incorporated by reference in its entirety.

### FIELD

This invention relates to a process for producing polymer compositions, particularly polyethylene blends, having a multimodal molecular weight distribution.

### BACKGROUND

Most polyethylenes are produced with either a narrow molecular weight distribution (M_{w}/Mₙ of 2 to 5) or a medium molecular weight distribution (M_{w}/Mₙ of 5 to 7). The conversion of reactor granules of such polyethylenes into finished product does not present any major difficulties. However, polyethylenes with broader molecular weight distribution (MWD) are desired in many applications because of the associated benefits, such as better processability, improved melt strength, etc. Combining two or more narrow MWD polyethylenes into bimodal or multimodal polyethylene compositions is a common approach to broaden MWD, and it is often accomplished by melt blending of the polyethylene components with different molecular weights. However, when the molecular weights of the blend components are far apart, it is very difficult to achieve homogeneous mixing and the resulting compound will contain large numbers of undispersed domains of usually the high molecular weight component showing as “gels” in film or “white spots” in pigmented products, such as pipes or blow molded articles.

Numerous studies have been published on different proposals for achieving uniform melt blending of two or more polymer components with very different molecular weight, such as by compounding at low shear rates, in a narrow temperature range near melting point, increasing mixing time to 1.5 minutes or above, increasing the mixing energy input, using gear-pump in addition to the melt-mixing apparatus, and even using fine mesh metal screens at melt discharge to further breakdown large undispersed particles. Examples of such publications include U.S. Pat. Nos. 6,031,027 and 6,545,093, U.S. Publication Nos. 2004/0192819 and 2007/0100132A1, and PCT Publication No. WO2010/081676A1.

However, with many of the existing approaches referred to above, polymer breakdown and deterioration of compound mechanical properties become a real issue. There is therefore a continuing need for an improved process for achieving uniform melt blending of two or more polymer components with very different molecular weight.

### SUMMARY

According to the present invention, it has now been found that by splitting the compounding into two or more stages and making the high viscosity component as the majority at each stage, the blend homogeneity is greatly improved and the mechanical properties of the compound is preserved. Without wishing to be bound by theory, it is believed that the poor mixing of polymer components with very different molecular weights results from the low shear stress developed from the matrix's low viscosity. When the low molecular weight component is the matrix, the shear stress applied on the dispersed high molecular weight droplets is too low to break the droplets apart in a timely fashion, thus resulting in very poor dispersion in single, double or even triple passes through an extruder.

Thus, in one aspect, the invention resides in a process of producing a multimodal polymer composition comprising a high molecular weight polymer (1) and a low molecular weight polymer (2), where the weight ratio of polymer (1) to polymer (2) is at a first value, x. The process includes compounding a mixture of polymer (1) and polymer (2) in a first compounding stage to form a first blend, wherein the weight ratio of polymer (1) to polymer (2) in the first blend is at a second value, y, such that 1<y>x, adding polymer (2) to the first blend, and compounding the mixture of polymer (2) and the first blend in a second compounding stage to produce a second blend. In another aspect, the invention resides in an article comprising the multimodal polymer composition formed from the disclosed process.

### DETAILED DESCRIPTION

A process is described for producing a multimodal polymer composition comprising a physical blend of a high molecular weight polymer (1) and a low molecular weight polymer (2), wherein the weight ratio of polymer (1) to polymer (2) is at a first value, x. The polymers (1) and (2) can be the same or different and can be formed of any polymeric material, with polyolefins, especially polyethylene, being preferred.

In some embodiments, the high molecular weight polymer has a melt flow index (I₂₁) of less than 20 g/10 minutes, such as less than 10 g/10 minutes, such as less than 5 g/10 minutes, such as less than 1 g/10 minutes, for example less 0.2 g/10 minutes, even less than 0.05 g/10 minutes, wherein such melt flow index values were determined according to ASTM D1238 (at 190° C. and a load of 21.6 kg). In some embodiment, the low molecular weight polymer (2) has a melt flow index (I₂) of at least 1 g/10 minutes, such as at least 10 g/10 minutes, such as at least 50 g/10 minutes, for example at least 100 g/10 minutes, even at least 200 g/10 minutes, wherein such melt flow index values were determined according to ASTM D1238 (at 190° C. and a load of 2.16 kg).

Alternatively, or additionally, the high molecular weight polymer (1) may have a weight average molecular weight (M_{w}) of greater than 1×10⁵ g/mol, such as at least 2×10⁵ g/mol, whereas the low molecular weight polymer (2) may have a M_{w} of less than 1×10⁵ g/mol, such as less than 0.5×10⁵ g/mol. The present process can be used with polymers having a narrow molecular weight distribution. In some embodiments, each of the high molecular weight polymer (1) and the low molecular weight polymer (2) has a relatively narrow molecular weight distribution, such that (M_{w}/Mₙ) is less than 8.0, such as less than 6, for example from 2 to 5, wherein Mₙ is the number average molecular weight of the polymer as determined by GPC.

Molecular weight distribution (“MWD”) is equivalent to the expression M_{w}/Mₙ. The expression M_{w}/Mₙ is the ratio of the weight average molecular weight (M_{w}) to the number average molecular weight (Mₙ). The weight average molecular weight is given by

$${M}_{w} = \frac{{\sum }_{i} {n}_{i} {M}_{i}^{2}}{{\sum }_{i} {n}_{i} {M}_{i}} ,$$

the number average molecular weight is given by

$${M}_{n} = \frac{{\sum }_{i} {n}_{i} {M}_{i}}{{\sum }_{i} {n}_{i}} ,$$

the z-average molecular weight is given by

$${M}_{z} = \frac{{\sum }_{i} {n}_{i} {M}_{i}^{3}}{{\sum }_{i} {n}_{i} {M}_{i}^{2}} ,$$

where nᵢ in the foregoing equations is the number fraction of molecules of molecular weight Mᵢ. M_{w}, Mₙ and M_{w}/Mₙ are determined by using a High Temperature Gel Permeation Chromatography (Agilent PL-220), equipped with three in-line detectors, a differential refractive index detector (DRI), a light scattering (LS) detector, and a viscometer. Experimental details, including detector calibration, are described in: T. Sun, P. Brant, R. R. Chance, and W. W. Graessley, Macromolecules, Volume 34, Number 19, pp. 6812-6820, (2001) and references therein. Three Agilent PLgel 10 μm Mixed-B LS columns are used. The nominal flow rate is 0.5 mL/min, and the nominal injection volume is 300 μL. The various transfer lines, columns, viscometer and differential refractometer (the DRI detector) are contained in an oven maintained at 145° C. Solvent for the experiment is prepared by dissolving 6 grams of butylated hydroxytoluene as an antioxidant in 4 liters of Aldrich reagent grade 1,2,4-trichlorobenzene (TCB). The TCB mixture is then filtered through a 0.1 μm Teflon filter. The TCB is then degassed with an online degasser before entering the GPC-3D. Polymer solutions are prepared by placing dry polymer in a glass container, adding the desired amount of TCB, then heating the mixture at 160° C. with continuous shaking for about 2 hours. All quantities are measured gravimetrically. The TCB densities used to express the polymer concentration in mass/volume units are 1.463 g/ml at room temperature and 1.284 g/ml at 145° C. The injection concentration is from 0.5 to 2.0 mg/ml, with lower concentrations being used for higher molecular weight samples. Prior to running each sample the DRI detector and the viscometer are purged. Flow rate in the apparatus is then increased to 0.5 ml/minute, and the DRI is allowed to stabilize for 8 hours before injecting the first sample. The LS laser is turned on at least 1 to 1.5 hours before running the samples. The concentration, c, at each point in the chromatogram is calculated from the baseline-subtracted DRI signal, IDRI, using the following equation:

c=K_{DRI}I_{DRI}/(dn/dc),

where K_{DRI} is a constant determined by calibrating the DRI, and (dn/dc) is the refractive index increment for the system. The refractive index, n=1.500 for TCB at 145° C. and λ=690 nm. Units on parameters throughout this description of the GPC-3D method are such that concentration is expressed in g/cm³, molecular weight is expressed in g/mole, and intrinsic viscosity is expressed in dL/g.

The LS detector is a Wyatt Technology High Temperature DAWN HELEOS. The molecular weight, M, at each point in the chromatogram is determined by analyzing the LS output using the Zimm model for static light scattering (M. B. Huglin, LIGHT SCATTERING FROM POLYMER SOLUTIONS, Academic Press, 1971):

$$\frac{{K}_{o} c}{Δ R ( θ )} = \frac{1}{M P ( θ )} + 2 {A}_{2} c .$$

Here, ΔR(θ) is the measured excess Rayleigh scattering intensity at scattering angle θ, c is the polymer concentration determined from the DRI analysis, A₂ is the second virial coefficient. P(θ) is the form factor for a monodisperse random coil, and Kₒ is the optical constant for the system:

$${K}_{o} = \frac{4 {π}^{2} {{n}^{2} ( d n / d c )}^{2}}{{λ}^{4} {N}_{A}} ,$$

where N_{A} is Avogadro's number, and (dn/dc) is the refractive index increment for the system, which take the same value as the one obtained from DRI method. The refractive index, n=1.500 for TCB at 145° C. and λ=657 nm.

A high temperature Viscotek Corporation viscometer, which has four capillaries arranged in a Wheatstone bridge configuration with two pressure transducers, is used to determine specific viscosity. One transducer measures the total pressure drop across the detector, and the other, positioned between the two sides of the bridge, measures a differential pressure. The specific viscosity, ηₛ, for the solution flowing through the viscometer is calculated from their outputs. The intrinsic viscosity, [η], at each point in the chromatogram is calculated from the following equation:

ηs=c[η]+0.3(c[η])²,

where c is concentration and was determined from the DRI output.

The branching index (g′ᵥᵢₛ) is calculated using the output of the GPC-DRI-LS-VIS method as follows. The average intrinsic viscosity, [η]_{avg}, of the sample is calculated by:

$${[ η ]}_{a v g} = \frac{\sum {{c}_{i} [ η ]}_{i}}{\sum {c}_{i}} ,$$

where the summations are over the chromatographic slices, i, between the integration limits. The branching index g′ᵥᵢₛ is defined as:

$${g}^{′} vis = \frac{{[ η ]}_{a v g}}{k {M}_{v}^{α}} .$$

Mᵥ is the viscosity-average molecular weight based on molecular weights determined by LS analysis. Z average branching index (g′_{Zave}) is calculated using Cᵢ=polymer concentration in the slice i in the polymer peak times the mass of the slice squared, Mi². All molecular weights are weight average unless otherwise noted. All molecular weights are reported in g/mol unless otherwise noted.

The weight ratio of polymer (1) to polymer (2), x, in the polymer blend produced by the present process ranges from about 0.1 to about 1.5, preferably from 0.7 to 1.3, and more preferably about 1.0.

The process employed to produce the present polymer blend comprises compounding a mixture of polymer (1) and polymer (2) in a first compounding stage to form a first blend, wherein the weight ratio of polymer (1) to polymer (2) in the mixture is at a second value, y, such that 1<y>x. In some embodiments, y is from 1.5× to 6×, such as from 1.5× to 2.5×, with preferred absolute values for y being >1.2, more preferably >1.4. Additional polymer (2) is then combined with the first blend and the resultant mixture of polymer (2) and the first blend is compounded in a second compounding stage to produce a second blend. In some embodiments, the second blend is arranged to have the target weight ratio of polymer (1) to polymer (2), x, whereas in other embodiments further addition(s) of polymer (2) followed by further compounding can be conducted until the target value of x is reached.

The temperature employed in each compounding step will vary depending on the compositions of polymers (1) and (2) and suitable temperatures are well known to those of ordinary skill in the art. For example, in the case of polyethylene, each of the first and second compounding stages is conveniently conducted at a temperature from 200 to 250° C.

The present process may be conducted by performing two or more passes on the same extruder or on different extruders. It is also possible to achieve good mixing by one-pass extrusion with downstream feeding. That is, an initial mixture of polymers (1) and (2) may be fed into the main feed port and compounded in a first mixing zone of an extruder with two or more banks of mixing elements, then the rest of polymer (2) component may be added downstream of the first mixing zone and prior to the second mixing zone. The advantage of this approach is less thermal/mechanical history on the compound and higher efficiency in time, energy and labor.

Using the present process, it is possible to achieve homogeneous mixing of two narrow molecular weight distribution polymer compositions with different M_{w} values without significant production of undispersed domains of the higher M_{w} component which would otherwise show as “gels” in film or “white spots” in pigmented products like pipe or blow molded articles. Without wishing to be bound by theory of operation, it is believed that at the high ratio of polymer (1) to polymer (2) used in the first compounding stage, the high molecular weight polymer (1) becomes the matrix and shear stress developed is high, which breaks apart the lower molecular weight polymer (2) domains efficiently. In the second compounding stage, the first blend still has a higher viscosity than the lower molecular weight polymer (2) but the viscosities of the two components are closer to each other, so the mixing with the additional polymer (2) component also takes place easily, thus achieving a much more homogeneous compound than a simple blend of polymer (1) to polymer (2) in double passes.

The invention will now be more particularly described with reference to the following non-limiting Examples. In the Examples, physical blends of two narrow molecular weight polyethylenes blended according to embodiments of the inventive method disclosed herein are evaluated. The narrow molecular weight polyethylenes, one having a low molecular weight and the other have a high molecular weight, were used in granular form as raw materials in a series of compounding experiments. To evaluate the degree of mixing between two single component polyethylenes, the example physical blends were compared to a bimodal reactor product. The bimodal reactor product is effectively a very homogeneous, in situ mixture of the high and low molecular weight raw materials.

The properties of the low molecular weight polyethylene, high molecular weight polyethylene, and comparative bimodal reactor product are summarized in Table 1. Density was measured according to ASTM D1505 using a density column and samples were prepared by compression molding under controlled cooling using a Wabash MPI Genesis compression molding press, Model #G304H-15-ASTM. The density of the high molecular weight material was calculated according to the following equation:

D_{HMW}=2*[D_{bimodal}−0.5*(D_{LMW})],

where D_{bimodal} is the measured density of the bimodal reactor product, D_{LMW} is the measured density of the low molecular weight polymer, and D_{HMW} is the density of the high molecular weight polymer. Melt index values (I₂ and I₂₁) given in Table 1 were measured following ASTM D1238 at 190° C. The high molecular weight material has a melt index that is too low to be measured. Molecular weight was measured by GPC-3D, as described above. Elongation at break was measured using compression molded Type IV tensile specimen according to ASTM D 638. Polymer samples were first compounded with a standard additive package prior to compression molding of test specimens. The molecular weight of the high molecular weight polymer is too high to be homogenously compounded with the standard additive package, and as such, could not be tested for comparison to the low molecular weight material and bimodal reactor product.

The low molecular weight single component polyethylene was made using a B-metallocene catalyst at 100° C. with a butene/ethylene ratio of 0.014 (mol/mol) and a hydrogen/ethylene ratio of 0.00255 (mol/mol). B-metallocene catalysts are discussed and described in U.S. Pat. No. 9,714,305 (Cols. 5-10 and FIG. 3-II) and U.S. Publication No. 2010/0041841, which are incorporated by reference.

The high molecular weight single component polyethylene was made using a Group 15 containing catalyst at 100° C. with a butene/ethylene ratio of 0.014 (mol/mol) and a hydrogen/ethylene ratio of 0.0030 (mol/mol). These catalysts may also be termed non-metallocene catalyst compounds. Group 15 containing catalysts are discussed and described in U.S. Pat. No. 9,714,305 (Cols. 10-12 and FIG. 3-I) and U.S. Publication No. 2010/0041841, which are incorporated by reference.

The comparison bimodal reactor polyethylene was produced in a single gas phase reactor using the PRODIGY™ BMC-300 Bimodal Catalyst available from Univation Technologies, LLC, with a nominal high load melt flow index (I₂₁) of 8.9 g/10 minutes and a nominal density between 0.948 and 0.951 g/m³. The single reactor bimodal product was made at 90° C. under a nominal reactor pressure of 2200 kPa with a butene/ethylene ratio of 0.012 (mol/mol) and a hydrogen/ethylene ratio of 0.0042 (mol/mol). The low molecular weight peak in the bimodal reactor product resin results from the same metallocene catalyst as the low molecular weight single component polyethylene, while the high molecular weight peak in the bimodal reactor product results from the same group 15 containing catalyst as the high molecular weight single component polyethylene.

TABLE 1

| | Low Molecular | High Molecular | Bimodal |
|---|---|---|---|
| | Weight | Weight | Reactor |
| Sample | Component | Component | Product |
| Density, g/cm³ | 0.9570/0.9569 | 0.944^{a} | 0.951 |
| I₂, g/10 min | 280/303 | Too low to measure | 0.06 |
| I₂₁, g/10 min | — | — | 8.9 |
| MFR (I₂₁/I₂) | — | — | 148 |
| Mₙ | 6067 | 82200 | 5113 |
| M_{w} | 24105 | 381670 | 218143 |
| M_{z} | 47332 | 1049430 | 1084400 |
| M_{w}/Mₙ | 4.0 | 4.6 | 42.7 |
| M_{z}/M_{w} | 2.0 | 2.7 | 5.0 |
| Elongation at break, | <20 | High^{b} | 842 |
| % | | | |

^{a}Value calculated from the densities of bimodal reactor product and the LMW component
^{b}Test method cannot be run with polymer at this molecular weight

The granules of high molecular weight and low molecular weight components were dry-blended with additives by drum tumbling for 30 minutes prior to compounding. The additive formulation used was: 1000 ppm Irganox-1010, 500 ppm Irgofas-168, 500 ppm zinc stearate and 1000 ppm calcium stearate.

Two different compounding extruders were used. They were a Baker and Perkin 18 mm (BP18) twin screw extruder with a screw diameter of 18.36 mm, length to diameter (L/D) ratio of 35 and maximum screw speed of 541 rpm, and a Coperion Werner and Pfleiderer ZSK30 twin screw extruder with a screw diameter of 30.7 mm, L/D ratio of 28 and a maximum speed of 500 rpm. The screw design of each extruder comprises two banks of kneading blocks with the rest being conveyor elements. The compounding conditions for BP18 were: Zone 1(Feed)/Zone 2/Zone 3/Zone 4/Zone 5/Zone 6/Die, 350/380/385/390/400/410/410° F., extruder speed 150 rpm, while those for the ZSK30 were: Feed Zone/Zone 1&2/Zone 3/Zone 4&5/Die, 300/350/380/400/420° F., extruder speed 100 rpm. Melt temperature, extruder torque and die pressure varied from sample to sample and are given in Tables 2 and 3 below.

Direct assessment of mixing quality was determined by defect analysis performed by an Optical Characterization System (OCS). The OCS Gel Counting Line typically consists of the following pieces of equipment: Brabender Extruder with a ¾ inch 20:1 UD compression screw; adjustable film slit die; OCS model FS3; and Killion chill roll and a film take-up system. The OCS system evaluates slightly over 1.0 m² of film per test. The targeted film thickness is 35 μm (0.001 inch or 1.4 mil). The OCS Model FS3 camera has a resolution of 7 μm and reads a film width of 12 mm. The camera system examines a section of the film in transmission mode, records as defects the areas that appear darker than the surrounding beyond a certain pre-set criterion, and logs in a report the specifics of each defect found. The OCS system doesn't distinguish different types of defects with certainty. Anything that scatters lights away or absorbs lights, thus appears darker under the camera, will be recorded as a defect, be it undispersed polymer component, catalyst remnant, foreign contamination like fiber or dirt, oxidized polymer particles or black specs due to degradation. However, users can define specific criteria based on size, darkness, aspect ratio, to single out certain types of defects. In this study, the majority of the defects were caused by undispersed particles of high molecular weight material. Key parameters used were the number of large defects (from 200 μm to 1 mm) and the normalized total defect area (TDA in mm²/m² or ppm) over the total examination area (3 m² or 6 m²). In an embodiment, a polymer blend mixed by the process disclosed herein has a normalized total defect area less than 6,000 ppm, or less than 1,000 ppm.

Direct assessment of mixing quality was determined by measurement of the elongation at break of compression molded Type IV tensile specimen according to ASTM D 638. Compression molding of the tensile specimen was also done under controlled cooling. While the defect analysis by OCS is a good characterization of mixing quality or dispersion of high molecular weight component, it doesn't contain direct information on resin breakdown. Tensile properties of the compound, more specifically elongation at break, are an indicator of both mixing quality and high molecular weight component breakdown. The elongation of the low molecular weight component is very low (<20%); adding in high molecular weight component causes it to increase. The bimodal reactor product, which is a well-mixed blend, has an elongation at break exceeding 800% at 50 mm/min testing rate. A poorly mixed blend will have low elongation at break dominated by the low molecular weight-rich matrix. As mixing improves, the dispersed high molecular weight component will boost the elongation at break and a well-mixed blend should have an elongation at break near 800%. However, if too much energy input was applied in the compounding step and caused significant breakdown of the high molecular weight component, then the system could be well-mixed but the elongation at break will decrease.

### EXAMPLE 1 (COMPARATIVE)

A one-pass blend of 50 wt % high molecular weight (HMW) component and 50 wt % low molecular weight (LMW) component was prepared in the BP18 extruder. The results are summarized in Table 2 and show very poor mixing quality. The blend has very high total defect area (TDA) and large gel counts. In addition, elongation at break is very low and the melt index (I₂₁) of the compound is very high. These properties indicate that the HMW component is not well dispersed; the melt flow and elongation at break are dominated by the LMW component.

### EXAMPLE 2 (COMPARATIVE)

The blend of Comparative Example 1 was re-extruded on the BPI8 extruder. The results are summarized in Table 2. The melt index and elongation at break are both trending toward the expected target. Although the mixing is much improved, the gel analysis still shows very high TDA and gel counts.

### EXAMPLE 3 (COMPARATIVE)

The blend of Comparative Example 1 was re-extruded on the ZSK30 extruder. The results are summarized in Table 2 and show significant improvement over Comparative Example 1, similar to but no better than Comparative Example 2.

TABLE 2

| | | | Example 3 |
|---|---|---|---|
| | Example 1 | Example 2 | HMW/LMW |
| | HMW/LMW | HMW/LMW | 50:50 |
| | 50:50 | 50:50 | BP18 1-pass |
| | BP18 1-pass | BP18 2-pass | 159 rpm + |
| Sample description | 159 rpm | 159 rpm | WP30 1-pass |
| Throughput (lbs/hr) | 17.8 | 8.6 | — |
| % Torque | 69 | 68 | 57.6 |
| Die Pressure (psi) | 295 | 715 | 761 |
| Melt temperature (° F.) | 429 | 429 | 448 |
| Density, g/cm³ | 0.9492 | 0.9493 | — |
| I₂, g/10 min | 1.45 | 0.11 | 0.12 |
| I₂₁, g/10 min | 206.3 | 12.0 | 13.5 |
| MFR (I₂₁/I₂) | 142 | 109 | 112 |
| Elongation at break, % | 50 | 744 | 661 |
| OCS TDA, ppm | 145,869 | 20,601 | 26,181 |
| # Gels > 200 micron, | 161,183 | 163,147 | 189,019 |
| 1/m² | | | |
| # Gels > 500 micron, | 58,464 | 20,779 | 27,972 |
| 1/m² | | | |
| # Gels > 1 mm, 1/m² | 25,242 | 308 | 1,179 |

### EXAMPLE 4

A blend of 60 wt % of the high molecular weight (HMW) component and 40 wt % mixture of the low molecular weight (LMW) component was first compounded on the BP18 extruder. The resulting blend was then diluted with additional LMW component to arrive at the 50 wt % HMW and 50 wt % LMW target and then compounded on the BP18 extruder. The results are summarized in Table 3 and show that TDA, gel counts, elongation at break and melt index all improved with large gels (>1 mm) decreasing to less than 1 per square meter.

### EXAMPLE 5

A blend of 65 wt % of the high molecular weight (HMW) component and 35 wt % of the low molecular weight (LMW) component was first compounded on the BP18 extruder. The resulting blend was diluted with additional LMW component to arrive at the 50 wt % HMW and 50 wt % LMW target and then compounded on the BP18 extruder. The results are summarized in Table 3 and show that the TDA and gel counts are better than those of Example 4, though elongation at break is slightly lower.

### EXAMPLE 6

A blend of 70 wt % of the high molecular weight (HMW) component and 30 wt % of the low molecular weight (LMW) component was initially compounded on the ZSK30 extruder. The resulting blend was diluted with additional LMW component to arrive at the 50 wt % HMW and 50 wt % LMW target and then compounded on the BP18 extruder. The results are summarized in Table 3 and show that the TDA and gel counts are further reduced significantly relative to Examples 1-5, but the lower elongation at break is indicative of mechanical breakdown.

TABLE 3

| | Example 4 | Example 5 | Example 6 |
|---|---|---|---|
| | Final | Final | Final |
| | HMW/LMW 50:50 | HMW/LMW 50:50 | HMW/LMW 50:50 |
| Sample description | (Initial H/L 60:40) | (Initial H/L 65:35) | (Initial H/L 70:30) |
| Throughput (lbs/hr) | 7.2 | 7.8 | 8.1 |
| % Torque | 78 | 76 | 86 |
| Die Pressure (psi) | 698 | 674 | 735 |
| Melt temperature (° F.) | 437 | 438 | 440 |
| Density, g/cm³ | 0.9474 | 0.9477 | 0.9484 |
| I₂, g/10 min | 0.08 | 0.09 | 0.1 |
| I₂₁, g/10 min | 9.1 | 11.2 | 12.0 |
| MFR (I₂₁/I₂) | 114 | 124 | 120 |
| Elongation at break, % | 826 | 745 | 580 |
| OCS TDA, ppm | 5,389 | 2,480 | 495 |
| # Gels > 200 micron, 1/m² | 45,593 | 23,782 | 1,031 |
| # Gels > 500 micron, 1/m² | 4,069 | 919 | 98 |
| # Gels > 1 mm, 1/m² | 0.7 | 0.7 | 0.3 |

While the present invention has been described and illustrated by reference to particular embodiments, those of ordinary skill in the art will appreciate that the invention lends itself to variations not necessarily illustrated herein. For this reason, then, reference should be made solely to the appended claims for purposes of determining the true scope of the present invention.

What is claimed is:

1. A process of producing a multimodal polymer composition comprising a high molecular weight polymer (1) and a low molecular weight polymer (2), wherein the weight ratio of polymer (1) to polymer (2) is at a first value x, the process comprising:
(a) compounding a mixture of polymer (1) and polymer (2) in a first compounding stage to form a first blend, wherein the weight ratio of polymer (1) to polymer (2) in the first blend is at a second value, y, such that 1<y>x;
(b) adding polymer (2) to the first blend; and
(c) compounding the mixture of polymer (2) and the first blend in a second compounding stage to produce a second blend.

2. The process of claim 1, wherein the weight ratio of polymer (1) to polymer (2) in the second blend is equal to x.

3. The process of claim 1, wherein the weight ratio of polymer (1) to polymer (2) in the second blend is greater than x and at least one further addition of polymer (2) and at least one further compounding stage are conducted to produce a final blend in which the weight ratio of polymer (1) to polymer (2) is equal to x.

4. The process of claim 1, wherein x is from 0.1 to 1.5.

5. The process of claim 1, wherein y is from 1.5× to 6×.

6. The process of claim 1, wherein each of the high molecular weight polymer (1) and the low molecular weight polymer (2) comprises polyethylene.

7. The process of claim 1, wherein the high molecular weight polymer (1) has an I₂ less than 20 g/10 minutes at 190° C. and a load of 21.6 kg.

8. The process of claim 1, wherein the low molecular weight polymer (2) has an I₂ of at least 1 g/10 minutes at 190° C. and a load of 2.16 kg.

9. The process of claim 1, wherein each of the high molecular weight polymer (1) and the low molecular weight polymer (2) has a molecular weight distribution (M_{w}/Mₙ) less than 8.0.

10. The process of claim 1, wherein the first and second compounding stages are conducted in separate extruders.

11. The process of claim 1, wherein the first and second compounding stages are conducted during separate passes through the same extruder.

12. The process of claim 1, wherein the first and second compounding stages are conducted in separate mixing zones of the same extruder during a single pass through the extruder.

13. The process of claim 1, wherein the first compounding stage is conducted at a temperature from 200 to 250° C.

14. The process of claim 1, wherein the second compounding stage is conducted at a temperature from 200 to 250° C.

15. A multimodal polymer composition formed from the process of claim 1.

16. The multimodal polymer composition of claim 15, wherein the multimodal polymer composition has a large gel count less than 1 per square meter.

17. The multimodal polymer composition of claim 15, wherein the multimodal polymer composition has a small gel count less than 50,000 per square meter.

18. The multimodal polymer composition of claim 15, wherein the multimodal polymer composition has a normalized total defect area (TDA) less than 1,000 ppm.

19. The multimodal polymer composition of claim 15, wherein the multimodal polymer composition has an elongation at break greater than 600% according to ASTM D 638.

20. An article comprising the multimodal polymer composition of claim 15.
